(19) United States
(12) Patent Application Publication
(10) Pub. No.: US 2009/0107399 A1
(43) Pub. Date: Apr. 30, 2009

(54) System and Method of Measuring Film Height on a Substrate

(76) Inventors: Harald Bloess, Radebeul (DE); Peter Reinig, Dresden (DE)

Correspondence Address: SLATER & MATSIL, L.L.P., 17950 PRESTON ROAD, SUITE 1000, DALLAS, TX, 75252, US

(21) Appl. No.: 11/927,043

(22) Filed: Oct. 29, 2007

(51) Int. Cl. B05C 11/00; G01B 11/06

(52) U.S. Cl. 118/712; 356/630

(57) ABSTRACT

A system of film height measurements and method of measuring film height on a substrate are disclosed. A radiation source illuminates a beam of radiation in the optical range onto a substrate being coated with a layer having a nominal film height is provided. Reflected signals are recorded for two positions and a film height difference of the layer is calculated.

### TECHNICAL FIELD

Embodiments of the invention relate to systems of film height measurements and methods of measuring film height on a substrate.

### BRIEF DESCRIPTION OF THE DRAWINGS

In the accompanying drawings:

FIG. 1 schematically illustrates an optical measurement system in a side view;

FIG. 2 schematically illustrates a substrate in a top view according to an embodiment;

FIG. 3 schematically illustrates an unstructured substrate in a top view according to a further embodiment;

FIG. 4 schematically illustrates a structured substrate in a top view according to a further embodiment;

FIG. 5 illustrates a characterization of film height values as a response to different color values according to a further embodiment;

FIG. 6 schematically illustrates a flow chart of method steps for performing measurement of film heights; and

FIG. 7 schematically illustrates a fabrication unit and a measurement system according to a further embodiment.

### DETAILED DESCRIPTION OF ILLUSTRATIVE EMBODIMENTS

Embodiments of methods and systems measuring film height on a substrate are discussed in detail below. It is appreciated, however, that the present invention provides many applicable inventive concepts that can be embodied in a wide variety of specific contexts. The specific embodiments discussed are merely illustrative of specific ways and do not limit the scope of the invention.

In the following, embodiments of the method and the system are described with respect to measuring film height on a substrate during manufacturing of an integrated circuit. The embodiments, however, might also be useful in other respects, e.g., improvements in process control, improvements in identifying lot to lot variations of a layout pattern, yield enhancement techniques or the like.

Furthermore, it should be noted that the embodiments are described with respect to film height measurements during production of integrated circuits but might also be useful in other respects and can be applied during manufacturing of other products, e.g., semiconductor circuits, thin film elements. Other products, e.g., liquid crystal panels or the like might be produced as well.

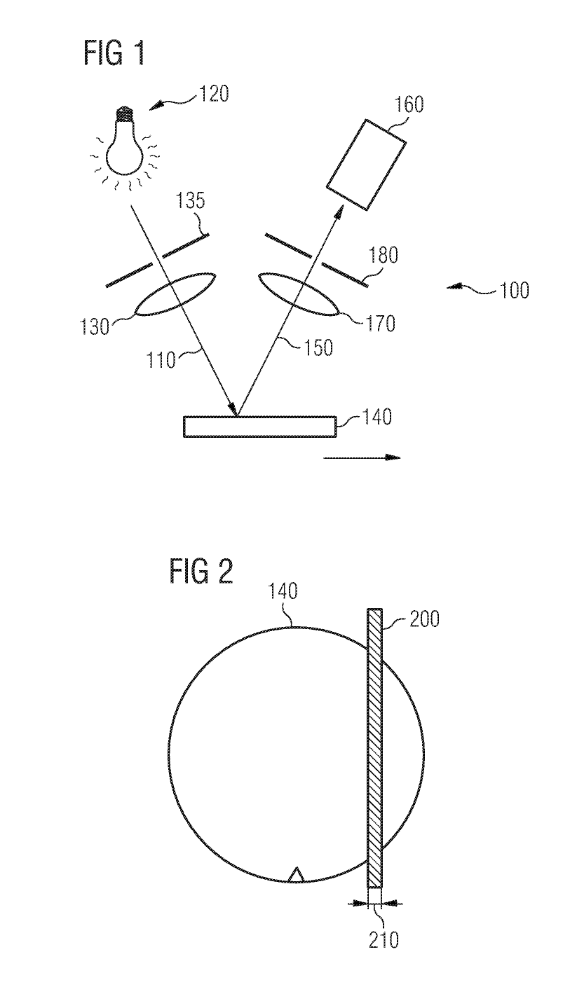

FIG. 1 illustrates basic elements of a photometric measurement system 100 shown in a side view. It should be noted, however, that FIG. 1 serves merely illustrative purposes and therefore does not provide full functionality of a photometric measurement system. Those skilled in the art will appreciate that there are many variations possible.

According to an embodiment of the invention the photometric measurement system 100 includes a radiation source 120 which is configured to emit a beam of radiation 110 onto a substrate 140. The light source 120 can be a lamp or a laser emitting radiation having a plurality of wavelengths in the visible range, i.e., serving as a polychromatic light source. The term “visible range” includes wavelength starting at about 300 nm up to approximately about 800 nm.

The emitted beam 110 is focused on the substrate 140. Focusing can be performed by employing a lens 130 together with an aperture stop 135 which are arranged between the radiation source 120 and the substrate 140. Furthermore, other optical devices like a polarizer for providing a linear, elliptical or radial polarized beam can be employed as well.

Substrate 140 reflects the incoming beam 110 from the surface as reflected beam 150. The reflected beam 150 shows an interfering behavior which results in a characteristic interference color depending on various properties of the surface of the substrate 140 as generally known with respect to interference colors of thin films on a substrate. It should be noted that the term “interference color” refers to a spectral color described by monochromatic light as well as a color value described by a composition of several wavelengths.

When a substrate 140 is coated with a layer on top of an optically reflecting surface, the color depends upon other properties of the film thickness of the layer, optical properties of the layer, the angle of incidence and the material properties of the layer.

Accordingly, a measurement of the color value is related to the film height of the layer on substrate 140. Furthermore, during manufacturing of integrated circuits the layer on top of substrate 140 can be manufactured such that the optical and material properties of the layer do not significantly vary. Accordingly, measurement of the color can be directly related to film thicknesses.

In order to perform measurements of color values, the reflected beam 150 is sampled on a detector 160. As shown in FIG. 1, beam 110 is at least partially reflected from substrate 140. The reflected beam 150 is collected and directed to the detector 160 which generates signals corresponding to a measured color value, for example. The output signals of detector 160 are transmitted to a processor which calculates profile parameters by evaluating the signals of the detector. The reflected beam 150 can be collected by a lens 170 and subjected to a further aperture stop 180, as shown in FIG. 1.

For manufacturing of integrated circuits, the surface of substrate 140 is typically patterned in different illumination areas which can be structured using a lithographic projection apparatus having an Excimer laser as a light source, for example. Light coming from the light source is projected through a photomask, which comprises a mask pattern, i.e., being composed of light absorptive or light attenuating elements.

The mask pattern is derived from a layout pattern which can be provided by a computer aided design system, in which structural elements of the layout pattern is generated and stored. The different illumination areas can be successively projected onto substrate 140. Typically, different illumination areas are surrounded by a cutting frame in which test structures or other elements not required for a functional circuit are arranged.

As shown in FIG. 1, the incident beam 110 can have a spot size being smaller than about 50 μm, for example. It is also conceivable to reduce the spot size to about 1 μm by employing suitable optical elements, like lenses 130 and 170. Furthermore, it is also possible that the beam 110 illuminates substrate 140 in a direction being perpendicular to the surface of substrate 140. This can be achieved by using a beam splitter between radiation source 120 and substrate 140, which directs part of the reflected beam towards detector 160 (not shown in FIG. 1).

In order to evaluate the signals, a measurement tool is provided which allows for absolute film height thickness measurements. For example, an ellipsometer or scatterometer can be used to determine the absolute film height thickness for one or more specific sample points while in regions between the sample points the color or color differences are used to determine thickness values of the layer.

It should be noted that the interference color determined during a photometric measurement can change its value for different film heights according to characteristic rainbow color spectrum, i.e., starting from violet, blue, yellow, green, red and then violet again, which repeats for different orders of interferences. Depending on coherency or light emitting area of radiation source 120, it is also possible to achieve non-spectral colors, i.e., a superposition of several wavelengths which are described by color values.

By comparing different color values at neighboring positions on substrate 140, a color map can be measured. By calibrating the color map with one absolute measurement, e.g., using scatterometry or the like, the film height differences between adjacent positions on the substrate can be translated into absolute film height values by observing the interference color sequence of the layer under investigation.

This is now further illustrated making reference to FIG. 2. FIG. 2 shows substrate 140 in a top view. The radiation source illuminates a slit like area 200 having a width 210 of about 50 μm or less. The reflected light is collected for a plurality of measurement sample points along area 200. By determining color values for the sample points along the whole slit like area 200, it is possible to calculate the film height after providing at least one absolute measurement.

Furthermore, it is possible to move the substrate 140 underneath the illumination area 200 so as to arrive at many color values for the whole substrate. This can be achieved by either moving the substrate 140 on a holder together with a rigidly installed measurement system 100. Other options, including proper light guides or moving the measurement system 100 instead of the substrate 140 or moving both the measurement system 100 and the substrate 140 are conceivable as well.

Accordingly, it is possible to calculate a set of film height values which are stored in a memory and can be compared to actual measurements, so as to arrive at a complete map of film height values for a plurality of sample points. It should be noted, however, that many other possible approaches can be used in order to arrive at a sample parameter. For example, the measurements can be performed iteratively or subsequently for different sample points on the substrate 140.

FIG. 2 shows a substrate 140 in a top view. The radiation source illuminates a slit like area 200 having a width of about 50 μm or less. The reflected light is collected for a plurality of measurement sample points along area 200. By determining color values for the sample points along the whole slit like area 200 and by moving the substrate 140, it is possible to calculate color values for the whole substrate.

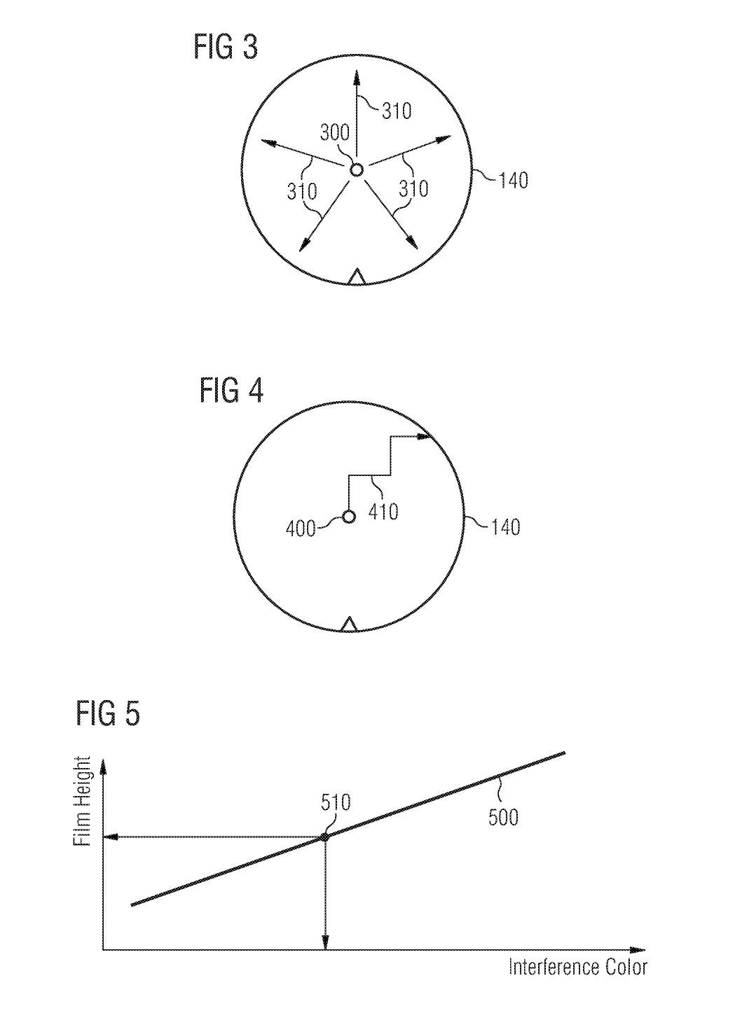

For an unstructured substrate 140, i.e., a substrate having a planar surface, the color values can be translated into film height values by providing at least one absolute measurement. As indicated in FIG. 3, the absolute value of the film height is determined at point 300. Under the assumption that neither step like variations of film heights nor step like variations of material properties of the layer are present, the changing color map can be translated into film heights, as described above.

FIG. 3 shows a substrate 140 in a top view. As shown in FIG. 3, the film height differences provided by the photometric measurements are converted into absolute values of the film height starting at point 300 and moving radially outside along directions 310.

In FIG. 4, a further embodiment is described with respect to a partially structured substrate, i.e., a substrate having been subjected to an etching or deposition step in a previous process sequence. Typically, regions in the cutting frame are not affected by these processing steps leaving at least a partial unstructured area in the cutting frame next to active layers of an integrated circuit. After the previous process sequence a layer is deposited on the entire substrate 140.

FIG. 4 shows a substrate 140 in a top view. The radiation source illuminates a slit like area having a width of about 50 μm or less. The reflected light is collected for a plurality of measurement sample points. By determining color values for the sample points along the whole slit like area and by moving the substrate 140, it is possible to calculate color values for interference colors for the whole substrate.

For the partially structured substrate 140, i.e., a substrate having a planar surface, the color values can only be derived in regions within the cutting frame. Furthermore, at least one absolute measurement is necessary in order to translate color values into film height values.

As indicated in FIG. 4, the absolute value of the film height is determined at point 400. Under the assumption that neither step like variations of film heights nor step like variations of material properties of the layer are present, the changing color map can be translated into film heights, as described above.

As shown in FIG. 4, the film height differences provided by the photometric measurements are converted into absolute values of the film height starting at point 400 and moving along a path 410 radially outward which is completely embedded in the cutting frame.

In order to arrive at film height differences the color value can be further investigated by providing a characteristic of film height differences versus interference color for several orders of interference.

As shown in FIG. 5, the film height values are shown as a response to different interference color values according to a further embodiment.

Here, color values according to characteristic interference colors, i.e., starting from and successively repeating violet, blue, yellow, green, red and then violet again are shown together with the associated film height differences derived by absolute calibration using, for example, a suitable spectroscopic measurement tool for one color value 510. It should be noted that the characterization of curve 500 can also be derived from theoretical model calculations.

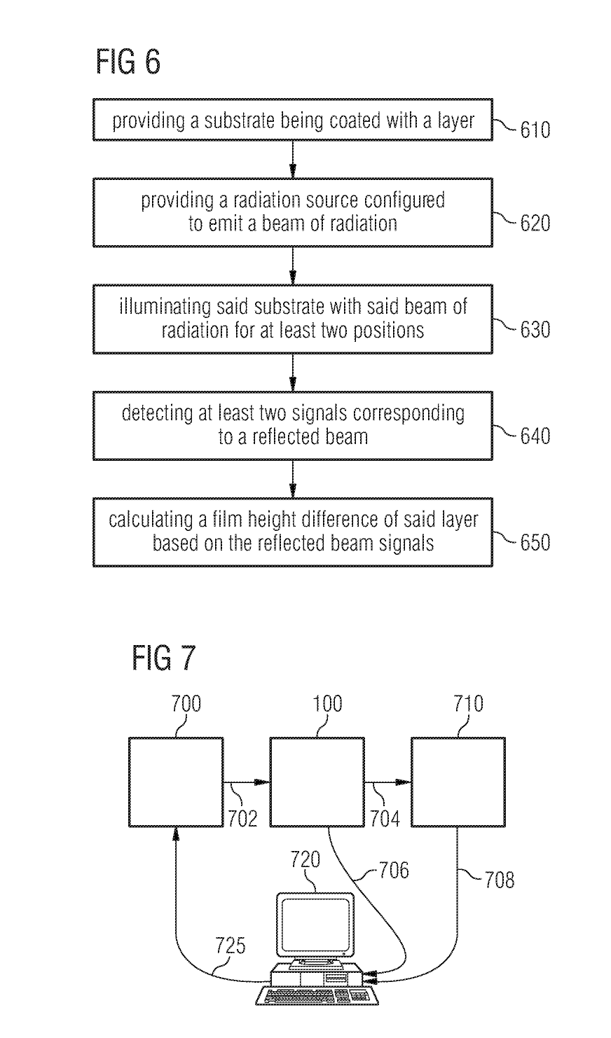

In FIG. 6, a flow diagram is shown with individual process steps capable of measuring dimensional parameters of structures on a substrate.

In step 610 a substrate is provided being coated with a layer having a nominal film height.

In step 620 a radiation source is provided configured to emit a beam of radiation having a wavelength in the optical range.

In step 630 the substrate is illuminated with the beam of radiation for at least two positions.

In step 640 a signal for at least two positions is detected which corresponds to radiation being reflected from the substrate.

In step 650 a film height difference of the layer is calculated.

As an example, semiconductor products usually require coating of a layer. According to an embodiment of the invention it is now possible to measure layer thicknesses even without employing other technologies like ellipsometry, reflectometry or scanning electron microscopy of a wafer cutted along the surface axis which is either time-consuming or may destroy the substrate 140.

As systems of measuring film height values on a substrate can be readily implemented into a fabrication unit of semiconductor manufacturing equipment, it is possible to achieve in situ measurements of layers having either structured or unstructured surfaces.

As shown in FIG. 7, a fabrication unit for manufacturing an integrated circuit can include a fabrication tool 700 capable of coating the substrate 140 with the layer. The substrate 140 is delivered to the measurement system 100 via a load port and a handler 702. The measurement system 100 can illuminate the substrate with the beam of radiation for at least two positions and the detector can record at least two signals.

The signals are forwarded via lines 706 to processor 720 which is capable of calculating a film height difference of the layer based on layer reflected beam signals for the at least two positions. The substrate 140 is forwarded to the absolute measurement system 710 which provides a film height for a specific point, as explained with respect to FIGS. 3 and 4. The processor is furthermore configured to control the fabrication unit based on the film height difference.

Having described embodiments of the invention, it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and the particularity required by the patent laws, what is claimed and desired to be protected by Letters Patent is set forth in the appended claims.

What is claimed is:

1. A method of measuring film height values on a substrate, the method comprising:
providing a radiation source configured to emit a beam of radiation in an optical range onto a substrate being coated with a layer having a nominal film height;
illuminating the substrate with the beam of radiation at least two positions;
detecting at least two signals, the signals corresponding to a respective part of the beam of radiation being reflected from the substrate for the at least two positions; and
calculating a film height difference of the layer based on the reflected beam signals for the at least two positions.

2. The method according to claim 1, further comprising providing a measurement tool, the measurement tool being capable of measuring film height values.

3. The method according to claim 2, wherein the measurement tool measures a first film height value at a first of the at least two positions.

4. The method according to claim 3, wherein a second film height value at a second of the at least two positions is calculated using the film height difference of the layer and the first film height value.

5. The method according to claim 1, wherein providing the substrate further comprises providing the substrate with a partially structured surface that is coated with the layer.

6. The method according to claim 5, wherein the beam illuminates the substrate in an unstructured region.

7. The method according to claim 1, wherein providing the substrate further comprises providing the substrate with a planar surface coated with the layer.

8. A method of measuring dimensional parameters of structures on a substrate, the method comprising:
providing a substrate coated with a layer having a nominal film height;
providing a photometric system, the photometric system having a radiation source configured to emit a beam of radiation and configured to illuminate the substrate with the beam of radiation at least two positions and having a detector configured to detect at least two signals, the signals corresponding to a respective part of the beam of radiation being reflected from the substrate for the at least two positions; and
calculating a film height difference of the layer based on the reflected beam signals for the at least two positions.

9. The method according to claim 8, further comprising coupling a processor to the signals, the processor calculating the film height difference based on the beam signals.

10. The method according to claim 8, wherein the beam is transmitted onto the substrate under an angle relative to a surface of the substrate.

11. The method according to claim 8, wherein the beam emits polychromatic radiation in a visible range.

12. The method according to claim 8, wherein the beam illuminates the substrate having a beam spot diameter smaller than about 50 μm.

13. The method according to claim 11, wherein the beam illuminates the substrate having a beam spot size diameter than about 1 μm.

14. The method according to claim 8, wherein the detector records a color value of the reflected beam as a signal.

15. The method according to claim 8, further comprising providing a measurement tool, the measurement tool being capable of measuring a first film height value at a first of the at least two positions and a second film height value at a second of the at least two positions is calculated using the film height difference of the layer and the first film height value.

16. A system for measuring dimensional parameters of structures on a substrate, the system comprising:
a photometric system, the photometric system having a radiation source configured to emit a beam of radiation having a wavelength in an optical range and configured to illuminate a substrate coated with a layer with the beam of radiation at least two positions, the photometric system further comprising a detector configured to detect at least two signals, the signals corresponding to a respective part of the beam of radiation being reflected from the substrate for the at least two positions; and
a processor coupled to the photometric system to calculate a film height difference of the layer based on the reflected beam signals for the at least two positions.

17. The system according to claim 16, wherein the beam emits radiation having a monochromatic wavelength.

18. The system according to claim 16, wherein the beam illuminates the substrate having a beam spot diameter smaller than about 50 μm.

19. The system according to claim 18, wherein the beam illuminates the substrate having a beam spot diameter smaller than about 1 μm.

20. The system according to claim 16, wherein the detector records a color value of the reflected beam as a signal.

21. The system according to claim 16, further comprising a measurement tool, the measurement tool configured to measure a first film height value at a first of the at least two positions and a second film height value at a second of the at least two positions.

22. A system of measuring film height values on a substrate, the system comprising:
means for providing a substrate being coated with a layer having a nominal film height;
means for providing a radiation source configured to emit a beam of radiation having a wavelength in an optical range;
means for illuminating the substrate with the beam of radiation for at least two positions;
means for detecting at least two signals, the signals corresponding to a respective part of the beam of radiation being reflected from the substrate for the at least two positions; and
means for calculating a film height difference of the layer based on the reflected beam signals for the at least two positions.

23. The system according to claim 22, wherein means for detecting at least two signals comprise a photochromic system.

24. A fabrication unit for manufacturing an integrated circuit, the fabrication unit comprising:
a fabrication tool capable of coating a substrate with a layer;
a photometric system, the photometric system having a radiation source configured to emit a beam of radiation having a wavelength in an optical range and configured to illuminate the substrate with the beam of radiation for at least two positions and a detector configured to detect at least two signals, the signals corresponding to a respective part of the beam of radiation being reflected from the substrate for the at least two positions; and
a processor capable of calculating a film height difference of the layer based on the reflected beam signals for the at least two positions.

25. The fabrication unit according to claim 24, wherein the processor is configured to control the fabrication unit based on the film height difference.
